(19) United States
(12) Patent Application Publication
(10) Pub. No.: US 2010/0180637 A1
(43) Pub. Date: Jul. 22, 2010

(54) METHOD AND APPARATUS FOR BENDING AND TEMPERING A GLASS PANEL

(75) Inventors: Pete Harjunen, Nokia (FI); Veijo Valtonen, Tampere (FI)

Correspondence Address: BUCHANAN, INGERSOLL & ROONEY PC, POST OFFICE BOX 1404, ALEXANDRIA, VA, 22313-1404, US

(73) Assignee: GLASTON SERVICES LTD. OY, Tampere (FI)

(21) Appl. No.: 12/600,932

(22) PCT Filed: Jun. 13, 2008
(86) PCT No.: PCT/FI2008/050357

§ 371 Date: Mar. 23, 2010

(30) Foreign Application Priority Data
Jun. 18, 2007 (FI) 20075461

(51) Int. Cl. C03B 23/023; C03B 23/00

(52) U.S. Cl. 65/104; 65/268

(57) ABSTRACT

The invention relates to a method and apparatus for bending a glass panel. A heated flat glass panel is fed from a furnace onto a bending conveyor while the bending conveyor is in a straight configuration. The bending conveyor and the glass panel are arched to a desired curvature while the glass panel travels along the bending conveyor. An interpolating position-setting for the tempering conveyor's upstream end with respect to the tempering conveyor's bending radius is performed in such a way that a certain point at the tempering conveyor's upstream end coincides with a certain point at the bending conveyor's stationary downstream end. This position-setting is performed by moving the tempering conveyor in vertical and horizontal directions and by pivoting the tempering conveyor so as to change an angle between its center line of curvature and a vertical line.

The invention relates to a method for bending and tempering a glass panel, said method comprising the steps of
heating a glass panel in a heating furnace for bending and tempering
feeding a flat glass panel from the furnace onto a bending conveyor with the bending conveyor in a straight configuration
arching the bending conveyor and the glass panel to a desired curvature with the glass panel moving along the bending conveyor, and
tempering the bent glass panel.

The invention relates also to an apparatus for bending and tempering a glass panel, said apparatus comprising
a heating furnace for heating glass panels to a bending temperature
a bending conveyor for bending glass panels, the bending conveyor comprising horizontal conveyor rolls
means for arching the bending conveyor to a curve matching the desired curvature of a glass panel
a tempering conveyor as an extension of the bending conveyor, and
means for cooling a bent glass panel for tempering.

Such a method and apparatus are known for example from the Applicant's patent publication EP-1597208 (B1). In this prior known apparatus, the bending and tempering processes are conducted on one and the same conveyor, which limits the apparatus in terms of its production capacity.

On the other hand, the patent publication FI-101697 discloses a method and apparatus, wherein a bending conveyor and a cooling conveyor are present separately as extensions of each other. In this prior known apparatus, the bending conveyor is in a configuration previously arched to a curve as it receives the glass. This is adverse for the reason that the glass is forced to bend at a single point of bending. Regarding the quality of a final product, it is beneficial that the glass should bend simultaneously over its entire bending distance.

It is an object of the invention to eliminate the capacity and quality problems associated with the above prior known solution and to provide a method and apparatus capable of producing high-quality tempered bent glass with a high capacity. A particular object of the invention is to resolve a double-conveyor problem in the sense that the conveyors are required to establish an integrally continuing arch, and at the same time must also have a capability of being arched independently of each other and even being disengaged from each other.

This object is achieved by a method presented in the appended claim 1. The object is also achieved by an apparatus presented in the appended claim 7. Preferred embodiments of the invention are presented in the dependent claims.

One exemplary embodiment of the invention will now be described more closely with reference to the accompanying drawings, in which

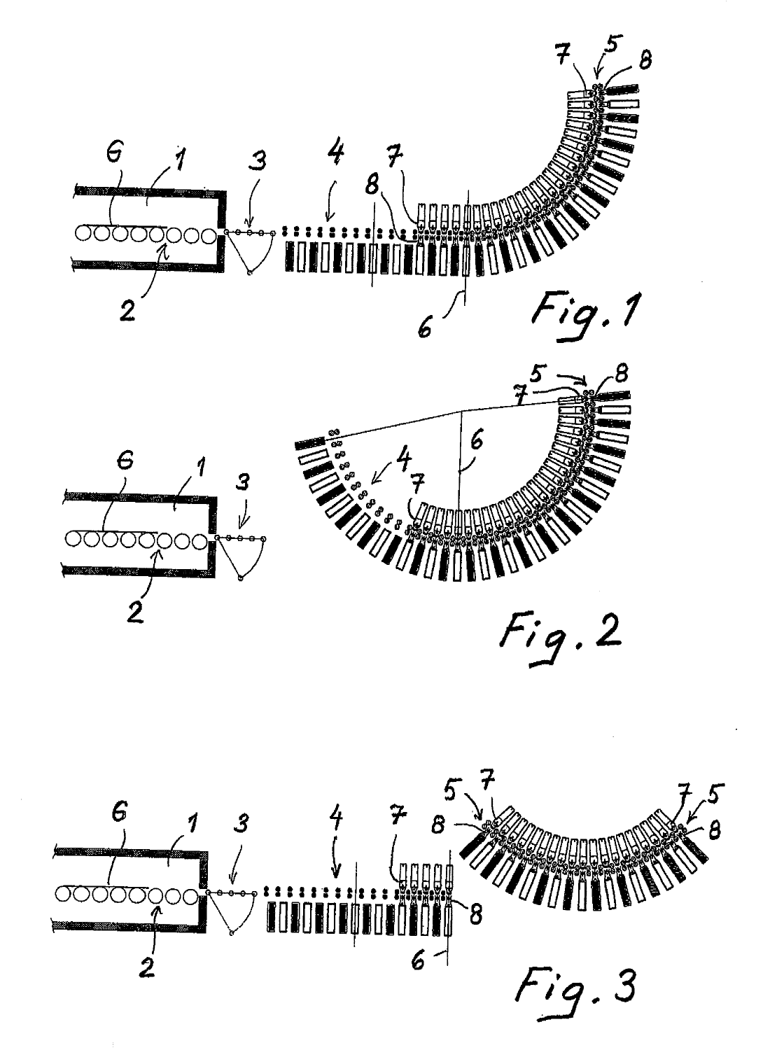

FIGS. 1-3 show schematically an apparatus of the invention in a side view during various working sequences.

FIG. 4 shows more closely a bending conveyor and a tempering conveyor in such a configuration that a tempering conveyor 5 has been arched to a desired radius of curvature R3 which is smaller compared to that R1 of a bending conveyor 4.

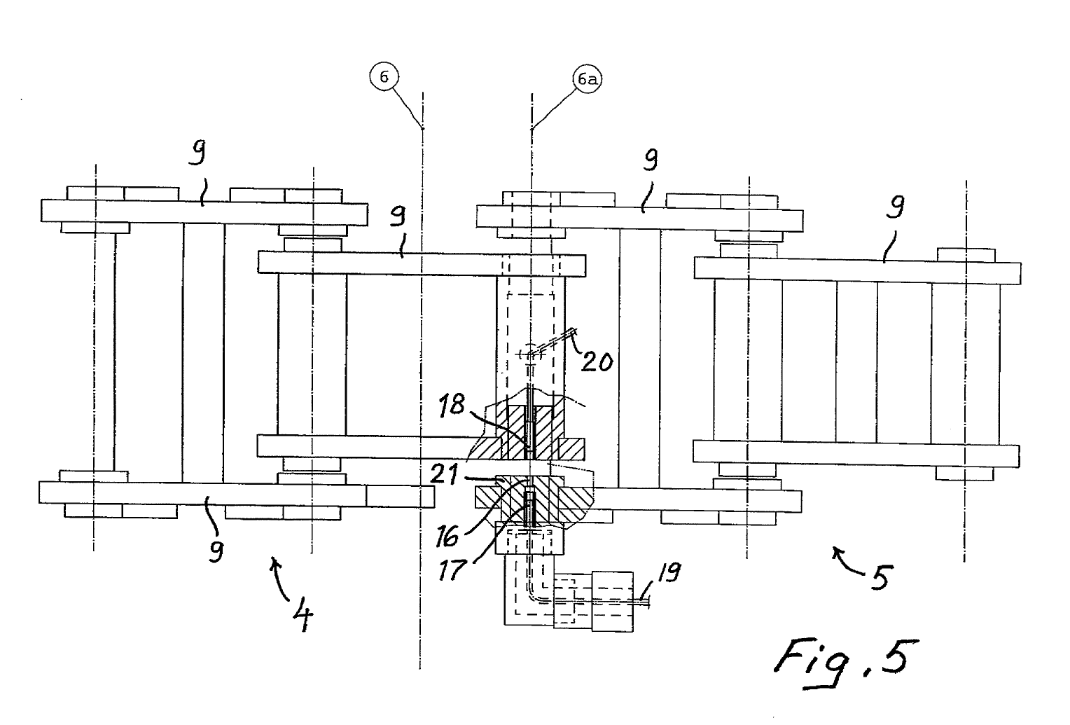

FIG. 5 shows schematically positioning means for the ends of the conveyors.

The apparatus according to the invention includes a heating furnace 1 for heating glass panels G therein to a bending temperature. From a furnace conveyor 2 the glass panel is passed by way of an intermediate conveyor 3 onto a bending conveyor 4, including horizontal conveyor rolls with press rolls thereabove. A gap between the conveyor rolls and the press rolls matches substantially the thickness of a glass panel. Present as an immediate extension of the bending conveyor 4 is a tempering conveyor 5, which also consists of horizontal conveyor rolls and press rolls spaced from the conveyor rolls by a distance matching the thickness of a glass panel. The tempering conveyor 5 is covered over its entire length by upper and lower tempering air enclosures 7 and 8, tracing a curvilinear outline of the conveyor. The bending conveyor 4 may also have tempering air enclosures 7 and 8 along its downstream end section. Reference numeral 6 represents a vertical line, along which the bending conveyor 4 and the tempering conveyor 5 can be disengaged from each other. The tempering conveyor 5 is typically slightly longer than the bending conveyor 4. Both conveyors have their press rolls provided with a drive, i.e. rotated at a peripheral speed equal to that of the conveyor rolls, as a result of which the press rolls function also as conveyor rolls.

In reference to FIG. 4, there is only shown link bodies 9 along both sides of the conveyors 4, 5, which are fitted with bearings for the conveyor rolls and the press rolls. The link bodies 9 are in turn connected to each other with a link mechanism (not shown), which forces the link bodies to pivot relative to each other over the same extent as the conveyor is being arched. Such a link mechanism has been described e.g. in the Applicant's patent EP-1385795 (B1). FIG. 4 illustrates a power unit 10 and a lever system 11, by means of which the bending conveyor 4 is adjustable in terms of its radius of curvature. The power unit 10 can be a servomotor, which by way of a clutch operates a ball screw 10a, which in turn pushes and/or pivots the lever system 11 upon which rests a bridge established by the link bodies 9.

FIG. 4 shows further how the tempering conveyor 5 is maneuverable in vertical and horizontal directions (h and w) at the same time as the angle of its center axis CL changes. This way, the tempering conveyor 5 can have its curvature varied regardless of the bending conveyor 4, with an articulation point 6a between the conveyors 4, 5 remaining nevertheless stationary. As the desired radius of curvature R1 changes, a curvature adjustment for the tempering conveyor 5 is performed independently of the bending conveyor. During a curvature adjustment for the tempering conveyor 5 performed while the process is ongoing, the end of said conveyor must not become disengaged from the articulation point 6a common to the conveyors 4, 5. Therefore, during a curvature adjustment, or immediately after the adjustment, the articulation point 6a for the conveyor 5 is set in position by a separate motion controller as well as by positioning means illustrated in FIG. 5, which include an alignment aperture 16 and a light transmitter 17 and a receiver 18 on the opposite sides of the aperture.

In the exemplary embodiment of FIG. 5, the light transmitter 17 and the receiver 18 are located at the ends of fiber optic cables 19 and 20 and establish a pair of photocells, one photocell 18 of which is located on a pivoting axis 6a of the bending conveyor's 4 last link body 9 and the other photocell 17 is located on a respective pivoting axis 6a of the tempering conveyor's 5 first link body 9. The photocell 17, which, depending on the propagation direction of light, can be e.g. a light transmitter, is mounted on a very same structural member 21 which includes the alignment aperture 16.

The transmission and reception ends of the fiber optic cables 19 and 20 are connected to a control unit (not shown), wherein a computer program determines positioning based on the amount of light passing between the pair of photocells 17, 18 through the alignment aperture 16. The amount of transmitted light expresses how well the axes 6a of the conveyors 4 and 5 are in registration with each other. The horizontal, vertical and deflection motions of the tempering conveyor 5, described subsequently in more detail, are programmatically determined with respect to the tempering conveyor's 5 curvature in such a way that the axes 6a of the conveyors 4, 5 are capable of being pre-aligned at a precision sufficient for reaching the operating range of the pair of photocells 17, 18, after which the axes 6a are brought to an exact alignment.

Thus, what is carried out during a curvature adjustment, or immediately thereafter, is an interpolating position-setting for the ends of these conveyors. In the conveying direction, the ends of the conveyors 4 and 5 are mechanically separate from each other in order to enable a curvature adjustment of the tempering conveyor 5 and to enable, whenever necessary (at small radii of curvature), a disengagement of the tempering conveyor 5 from the bending conveyor 4. The downstream end of the bending conveyor 4 remains stationary at all times. Indicated by arrows 15 are power units for bringing rollers 14 up and down (vertical action h). In addition, the rollers 14 are able to travel (while maintaining the relative distance between themselves) in a horizontal direction at the same time as a swing frame 13 supporting the conveyor 5 is pivoted while supported upon the rollers 14. The swing frame 13 has its pivoting axis coinciding with the midpoint of an arch which extends through the articulated axles of the conveyor's 5 link bodies 9.

The arching mechanism for the tempering conveyor 5 comprises a motion element 12a movable by a servomotor (not shown), which through the intermediary of arms 12b arches a bridge established by the link bodies 9, and at the same time the entire conveyor resting upon the link bodies 9.

The method according to the invention is implemented with the above-described apparatus as follows. A glass panel G is heated in the furnace 1 to a temperature appropriate for bending and tempering. The flat glass panel G is delivered from the furnace 1 onto the bending conveyor 4 while the latter is in a straight configuration (FIG. 1). The tempering conveyor 5 has been previously arched to a desired curve as early as or even prior to having the flat glass panel received by the flat bending conveyor 4. The glass panel's exit speed from the furnace is e.g. 700 mm/s and the speed is decelerated over the period of e.g. 1 second to a speed of 400 mm/s at the same time as the glass panel passes onto the bending conveyor 4. The exit speed from the furnace can also be lower, e.g. 550 mm/s, and the deceleration proceeds to a speed of less than 300 mm/s. Arching of the bending conveyor 4 to a desired curve R1 is initiated even before the glass panel's trailing end section has completely reached the bending conveyor 4. Arching of the bending conveyor 4 is performed very quickly, typically within 1-2 seconds. That period is enough for the glass panel's leading edge to reach a position in line with tempering air enclosures 7, 8 present at the downstream end of the bending conveyor 4. Tempering blast is now activated and the conveying speed of a bent glass panel is increased to some degree.

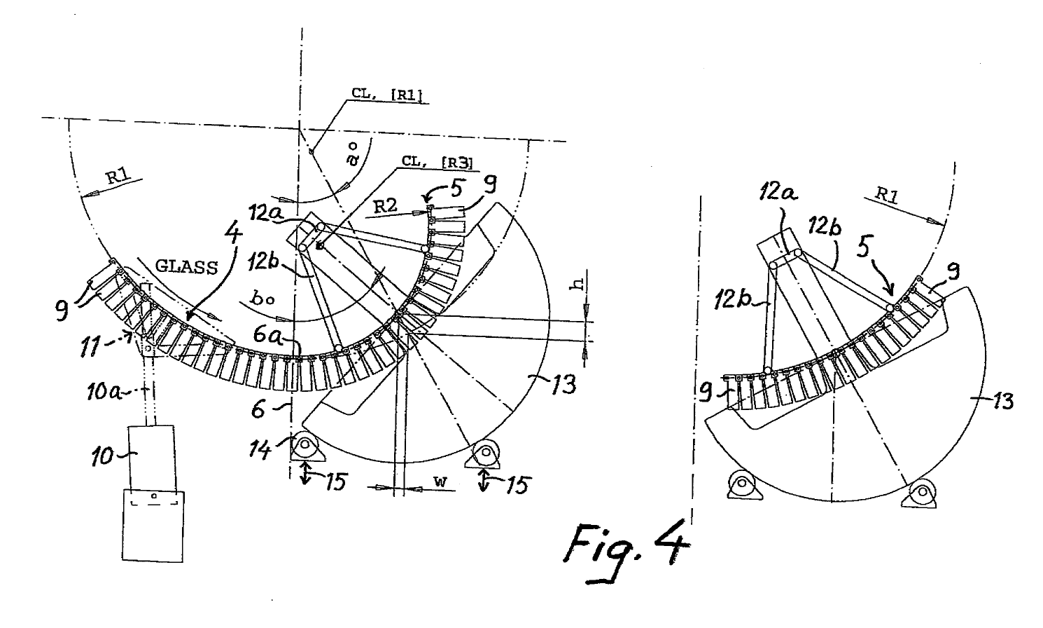

FIG. 4 illustrates, in an overstated manner for clearer visualization, the way how the tempering conveyor 5 can be arched during the process to a radius of curvature R3 slightly smaller or larger than the desired radius of curvature R1. This arching of the tempering conveyor 5 to the smaller or larger radius R3 is first of all enabled by virtue of the previously mentioned freedoms of movement (h, w and an angle a°), as well as by virtue of the mentioned interpolating position-setting, while the articulation point 6a between the conveyors 4, 5 remains stationary. Arching of the tempering conveyor 5 during the process is sufficiently slight not to cause a change in the glass panel's radius of curvature R1, but nevertheless clamps the glass panel between conveyor rolls and press rolls to such a tightness that the glass panel is able to proceed upward even along a steep arch without slipping. Thus, tempered glass panels can be discharged even vertically straight upward to an appropriate manipulator, which receives the glass panel. However, if necessary, the tempering conveyor 5 can also be disengaged from the bending conveyor 4, enabling the tempering conveyor 5 to be pivoted as a whole for diminishing the vertical drop between its discharge end and midpoint (see e.g. FIG. 3). Consequently, the glass panel can be discharged from the tempering conveyor 5 at quite a low angle with respect to the horizontal plane, without having to move the glass panel in vertical direction.

Whenever the apparatus is used to produce bent and tempered glass panels in succession with the same desired radius of curvature R1, the curvature of the tempering conveyor 5 is retained the same at all times, except for a very slight increase of curvature during the process. Other than that, the only time that the curvature of the tempering conveyor 5 needs changing is when the desired curvature R1 changes.

The method and apparatus according to the invention are also particularly apt for the production of bidirectionally curved glass panels. In this case, the rolls are also subjected to deflection, as described e.g. in the Applicant's patent publication EP-1597208 (B1).

1. A method for bending and tempering a glass panel, said method comprising the steps of:
heating a glass panel in a heating furnace for bending and tempering
feeding a flat glass panel from the furnace onto a bending conveyor with the bending conveyor in a straight configuration
arching the bending conveyor and a glass panel to a desired curvature while the glass panel travels along the bending conveyor, and
tempering the bent glass panel on a tempering conveyor
wherein an interpolating position-setting is performed for the tempering conveyor's upstream end with respect to the tempering conveyor's bending radius, such that a certain point at the tempering conveyor's upstream end coincides with a certain point at the bending conveyor's stationary downstream end, and that wherein said position-setting is performed by moving the tempering conveyor in vertical and horizontal directions and by pivoting the tempering conveyor so as to change an angle between its center line and a vertical line.

2. A method as set forth in claim 1, wherein the tempering conveyor's curvature is changed and said interpolating position-setting is performed at the same time or immediately thereafter.

3. A method as set forth in claim 1, wherein the bent glass panel is delivered from the bending conveyor onto the tempering conveyor present as its extension, which is previously arched to a desired curvature as early as or prior to a flat glass panel is received by the straight bending conveyor.

4. A method as set forth in claim 1, wherein the tempering conveyor is arched during the course of a tempering process to a bending radius slightly smaller than a bending radius desired for a glass panel, yet in such a way that the glass panel does not change its curvature on the tempering conveyor but, instead, the glass panel only becomes tightly clamped between the upper and lower tempering conveyor rolls.

5. A method as set forth in claim 1, wherein, in the process of arching the bending conveyor and/or the tempering conveyor, an articulation point between the conveyors remains stationary.

6. A method as set forth in claim 1, wherein the tempering conveyor is disengaged from the bending conveyor and the tempering conveyor is pivoted as a whole in such a way that the vertical drop between its discharge end and its midpoint decreases without changing the tempering conveyor in terms of its curvature.

7. A method as set forth in claim 1, wherein the position-setting is performed by using a beam of light traveling through an alignment aperture.

8. An apparatus for bending and tempering a glass panel, said apparatus comprising:
a heating furnace for heating glass panels to a bending temperature
a bending conveyor for bending glass panels, the bending conveyor comprising horizontal conveyor rolls,
means for arching the bending conveyor to a curve matching the desired curvature of a glass panel,
a tempering conveyor as an extension of the bending conveyor, and
means for cooling the bent glass panel for tempering,
wherein
the bending conveyor's downstream end is stationary in its position,
the tempering conveyor's upstream end is capable of moving in a conveyance-directed plane with respect to the bending conveyor's stationary downstream end,
i.e. the conveyors' interconnecting ends are mechanically disengaged from each other in said traveling direction, and
wherein the apparatus is provided with positioning means for positioning the tempering conveyor's upstream end at the same location with respect to the bending conveyor's stationary downstream end.

9. An apparatus as set forth in claim 8, wherein the bending conveyor is adapted to receive a flat glass panel while itself in a straight configuration and the bending conveyor is followed by an arching-ready tempering conveyor, which is already in a configuration arched to a desired curve even as the bending conveyor is still in a straight configuration.

10. An apparatus as set forth in claim 8, wherein the tempering conveyor is maneuverable in vertical and horizontal directions at the same time as angle of its center axis is variable, while an articulation point between the conveyors remains stationary during said maneuvering.

11. An apparatus as set forth in claim 8, wherein the tempering conveyor is capable of being disengaged from the bending conveyor and the tempering conveyor is capable of being pivoted as a whole in such a way that the vertical drop between its discharge end and its midpoint decreases without changing the tempering conveyor in terms of its curvature.

12. A method as set forth in claim 2, wherein the tempering conveyor is arched during the course of a tempering process to a bending radius slightly smaller than a bending radius desired for a glass panel, yet in such a way that the glass panel does not change its curvature on the tempering conveyor but, instead, the glass panel only becomes tightly clamped between the upper and lower tempering conveyor rolls.

13. A method as set forth in claim 3, wherein the tempering conveyor is arched during the course of a tempering process to a bending radius slightly smaller than a bending radius desired for a glass panel, yet in such a way that the glass panel does not change its curvature on the tempering conveyor but, instead, the glass panel only becomes tightly clamped between the upper and lower tempering conveyor rolls.

14. A method as set forth in claim 2, wherein, in the process of arching the bending conveyor and/or the tempering conveyor, an articulation point between the conveyors remains stationary.

15. A method as set forth in claim 3, wherein, in the process of arching the bending conveyor and/or the tempering conveyor, an articulation point between the conveyors remains stationary.

16. A method as set forth in claim 4, wherein, in the process of arching the bending conveyor and/or the tempering conveyor, an articulation point between the conveyors remains stationary.

17. A method as set forth in claim 2, wherein the tempering conveyor is disengaged from the bending conveyor and the tempering conveyor is pivoted as a whole in such a way that the vertical drop between its discharge end and its midpoint decreases without changing the tempering conveyor in terms of its curvature.

18. A method as set forth in claim 3, wherein the tempering conveyor is disengaged from the bending conveyor and the tempering conveyor is pivoted as a whole in such a way that the vertical drop between its discharge end and its midpoint decreases without changing the tempering conveyor in terms of its curvature.

19. A method as set forth in claim 4, wherein the tempering conveyor is disengaged from the bending conveyor and the tempering conveyor is pivoted as a whole in such a way that the vertical drop between its discharge end and its midpoint decreases without changing the tempering conveyor in terms of its curvature.

20. A method as set forth in claim 5, wherein the tempering conveyor is disengaged from the bending conveyor and the tempering conveyor is pivoted as a whole in such a way that the vertical drop between its discharge end and its midpoint decreases without changing the tempering conveyor in terms of its curvature.
